(19) United States
(12) Patent Application Publication
(10) Pub. No.: US 2004/0240563 A1
(43) Pub. Date: Dec. 2, 2004

(54) Video preprocessor

(76) Inventors: Yi-Jen Chiu, Holmdel, NJ (US); Yi Zeng, Eatontown, NJ (US)

Correspondence Address: Docket Administrator (Room 3J-219), Lucent Technologies Inc., 101 Crawfords Corner Road, Holmdel, NJ, 07733-3030, US

(21) Appl. No.: 10/448,185

(22) Filed: May 29, 2003

(51) Int. Cl. H04N 7/12

(52) U.S. Cl. 375/240.29; 375/240.12; 375/240.25

(57) ABSTRACT

When an intended display has a capability for displaying less bits per pixel than in a source video signal, a coding efficiency is obtained by preprocessing the digital video prior to its being encoded for transmission or storage to contain no more information, i.e., to have no greater resolution, than if the original digital video was formatted using the reduced-pixel-depth format that is eventually to be used by the display device reconstructing the video. This is achieved by first converting the original digital signal to the reduced-pixel-depth format displayable by the display, which typically results in information loss, and then reconverting it back to full RGB24 format. Doing so also improves image quality when lossy coding, e.g., MPEG-like coding, is employed rather than lossless coding. The preprocessor may also perform a further prescribed reduction in the resolution of the chrominance component of the video signal.

### TECHNICAL FIELD

This invention relates to the art of video encoding for transmission or storage prior to display.

### BACKGROUND OF THE INVENTION

Video reconstructed from a stored or transmitted video signal that is to be displayed on a full-sized display with sufficient memory to display the signal in full resolution is typically reconstructed in RGB24 format, i.e. using 9 bits for each of the primary colors red, green, and blue, which is referred as having a pixel depth of 8. However, when the reconstructed video is to be displayed on a device having a small screen and limited memory, e.g., on a PDA or cell-phone-type device, the video is often converted prior to display from RGB24 format to one of several reduced-pixel-depth formats, such as RGB565, RGB555, and RGB444. These reduced-pixel-depth formats have less information than was in the original video signal because a smaller number of bits is used to represent each of the R, G, and B video components. For example, instead of using 8 bits for each of the R, G, and B, for RGB565 only 5 bits are used for each of R and B while only 6 bits are used for G. Hence the video resolution that is displayed is reduced.

### SUMMARY OF THE INVENTION

We have recognized that a coding efficiency may be obtained when the intended display has a capability for displaying only less bits per pixel than are actually contained in the source video signal, in accordance with the principles of the invention, by preprocessing the digital video prior to its being encoded for transmission or storage to contain no more information, i.e., to employ no more bits per pixel, than if the original digital video was formatted using the reduced-pixel-depth format that is eventually to be used by the display device reconstructing the video. In other words, the digital bit stream is preprocessed so that even when it is encoded for storage or transmission by a lossless process, e.g., joint picture expert group—lossless (JPEG-LS), the retrieved or received video signal contains no more information than could be displayed at the display because it effectively only contained the reduced-pixel-depth format displayable by the display. This is achieved by first converting the original video signal to the reduced-pixel-depth format displayable by the display, which typically results in information loss, and then converting the reduced pixel version back to the full pixel-depth format, e.g., RGB24.

Advantageously, in addition to improving coding efficiency, image quality enhancement is also achieved when lossy coding, such as motion picture expert group (MPEG)-like coding, rather than lossless coding is employed.

In some embodiments of the invention, the preprocessor may also perform a further prescribed reduction in the resolution of the chrominance component of the video signal. Note that the chrominance component of the video signal has two portions, commonly referred, to as Cb and Cr, with Y being the luminance component when the video is characterized in the YCbCr video representation system. In such embodiments of the invention, a postprocessor is required between the decoder and the display to account for the reduction in resolution of the chrominance signal and to properly reconstruct the video signal in a form that can be displayed by the display.

Furthermore, when using lossless coding, instead of converting the reduced-pixel-depth format displayable by the display back to full RGB24 format for use by the encoder, it is possible to store or transmit the reduced-pixel-depth format version of the signal and then use a post processor to convert the received video signal back to RGB24 format, which is the only format receivable and understandable by the display. Advantageously, doing so reduces the storage or bandwidth required for the video signal.

### BRIEF DESCRIPTION OF THE DRAWING

In the drawing:

FIG. 1 shows an exemplary system for encoding, transmitting or storing, and reconstructing video in accordance with the principles of the invention.

### DETAILED DESCRIPTION

The following merely illustrates the principles of the invention. It will thus be appreciated that those skilled in the art will be able to devise various arrangements that, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown.

The functions of the various elements shown in the FIGS., including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementor as more specifically understood from the context.

In the claims hereof any element expressed as a means for performing a specified function is intended to encompass any way of performing that function including, for example, a) a combination of circuit elements which performs that function or b) software, in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein.

Software modules, or simply modules which are implied to be software, may be represented herein as any combination of flowchart elements or other elements indicating performance of process steps and/or textual description. Such modules may be executed by hardware that is expressly or implicitly shown.

Unless otherwise explicitly specified herein, the drawings are not drawn to scale.

In the description, identically numbered components within different ones of the FIGs. refer to the same components.

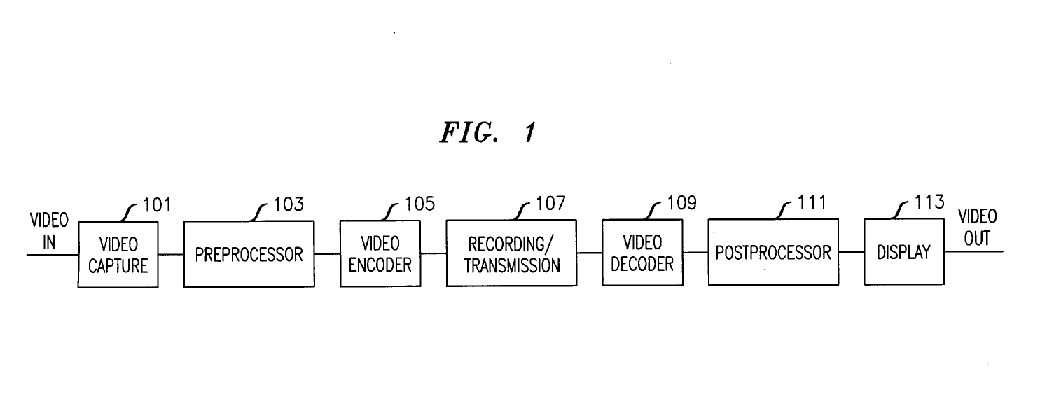

FIG. 1 shows an exemplary system for encoding, transmitting or storing, and reconstructing video in accordance with the principles of the invention. Shown in FIG. 1 are a) optional video capture 101, b) preprocessor 103, c) video encoder 105, d) storage or transmission medium 107, e) video decoder 109, f) optional postprocessor 111, and g) reduced-resolution display 113.

The original, full information content video signal, e.g., in analog format, is supplied to optional video capture 101. Video capture 101 performs a digitization of the video signal, e.g., into the 8 bit color depth RGB24 format. Video capture 101 may also perform conversion of the RGB24 format into a luminance and chrominance format, e.g., YCbCr, YUV, YIQ, and YCC. In any event, regardless of the particular format, video capture 101 supplies a full-information digital version of the original analog video signal to preprocessor 103.

Preprocessor 103 receives a full-information digital version of an original analog video signal, e.g., from optional video capture 101. However, the full-information digital version of an original analog video signal may instead be obtained from another source, e.g., received via transmission or obtained from a stored file. In accordance with the principles of the invention, preprocessor 103 process the received full-information digital video signal to contain no more information, i.e., to have no greater resolution, than can be displayed by reduced-resolution display 113 that is eventually to be used to display the reconstructed video. In other words, the digital bit stream containing the digital video signal is preprocessed so that even if it was conveyed by a lossless process to reduced-resolution display 113, the received information would contain no more information than could be displayed at display 113, because it effectively only contained the reduced resolution displayable by the display.

To this end, in accordance with an aspect of the invention, preprocessor 103 first converts the received digital video signal to a reduced-pixel-depth format displayable by the display, which typically results in information loss. Note that the transform of RGB24 space into a reduced-pixel-depth space is many-to-one. In other words, there are many possible ways to transform the RGB signal into a reduced-pixel-depth representation, all of them equally valid. Thus, the conversion of a signal y in RGB24 representation, where y is a three component vector in RGB space having components R, G, and B, into a signal z, again a three component vector in RGB space but having a reduced-pixel-depth, can generally be represented as z=F(y). In accordance with an aspect of the invention, the information of the resulting information-reduced video signal is then mapped back into a full resolution format, e.g., by computing y=G(z), where G is a function that maps from the reduced-pixel-depth space back to the full-pixel-depth space. Functions F and G may be linear or non-linear transforms, although for pedagogical purposes and clarity of exposition only linear examples are presented hereinbelow. The particular function employed is at the discretion of the implementer.

Preprocessor 103 is also able to convert the format of the received digital video signal, e.g., KGB, into a format that it employs to perform its resolution reduction, e.g., YCbCr. This may be achieved when, for example, a signal y is in RGB space and it is desired to derive therefrom a signal x, where x is a three component vector having components Y, Cb, and Cr in YCbCr space, by performing the transformation x=By+D, where B and D are matrices of scalar values that are specified for the RGB to YCbCr transformation process in accordance with various international standards and “·” is the dot product operator. If the video supplied to preprocessor 103 is already in the format that it needs to perform the resolution reduction, then no format conversion is required. Similarly, preprocessor 103 may perform the conversion from YCbCr space back to RGB space may using the transformation y=A·x+C, where A and C are matrices of scalar values that are specified for the YCbCr to RGB transformation in accordance with various international standards and “·” is the dot product operator.

Thus, in most general terms, in one embodiment of the invention preprocessor 103 calculates B(G(F(Ax+C)))+D, where “·” is the dot product operator, which it then supplies as an output. The calculation is arranged in this manner assuming that encoder 105 requires that its input to be in YCbCr format, as MPEG encoders are wont to require, and so it is assumed that the input and output to preprocessor 103 is in YCbCr format.

Matrices A, B, C and D may be those specified in ITU-R Recommendation BT.605-5, “Encoding Parameters of Digital Television for Studios”, October, 1995, which is incorporated by reference as if set forth fully herein. Those of ordinary skill in the art will readily be able to employ the techniques of the invention with other transform matrices and even other transforms.

$$\begin{matrix}A = ( \begin{matrix}1.0 & 0 & 0.114 \\ 1.0 & - 0.336 & - 0.698 \\ 1.0 & 1.732 & 0\end{matrix} ) & C = ( \begin{matrix}- 175.5 \\ 132.4 \\ - 221.7\end{matrix} ) \\ B = ( \begin{matrix}0.299 & 0.587 & 0.114 \\ - 0.172 & - 0.339 & 0.511 \\ 0.511 & - 0.428 & - 0.083\end{matrix} ) & D = ( \begin{matrix}0 \\ 128.0 \\ 128.0\end{matrix} )\end{matrix}$$

In one embodiment of the invention, preprocessor 103 employs a linear right-shift technique for function F, where the right shift operator is denoted as “>>”. Employed for function G is a left shift operator, denoted as “<<”. For a given shift amount Δ, preprocessor 103 computes B·(((A·x+C)>>Δ)<<Δ)+D, and supplies the result as its output. For RGB24 to RGB565, shift amount Δ is 3 bits for the R and B components and 2 bits for the G component. This is equivalent to dividing the R and B components by 8 and the G component by 4. For RGB24 to RGB444, shift amount Δ is 4 bits for all components and it is equivalent to dividing all the components by 16.

In another embodiment of the invention, preprocessor 103 again employs a linear right-shift technique with magnitude adjustment. However, employed for function G is a left shift operator with a magnitude adjustment. The magnitude adjustment may be used to better center the reconstructed values. For a given shift amount A, preprocessor 103 computes

B·(((A·x+C)>>Δ)<<Δ+(1<<(Δ−1)))+D,

and supplies the result as its output. Thus, function G is the same as in the preceding embodiment of the invention, but it is modified to further add an amount equal to 1 shifted to the left by one less than Δ.

In some embodiments of the invention, described further hereinbelow, preprocessor 103 may also perform a further prescribed reduction in the resolution of the chrominance component of the video signal. In yet further embodiments of the invention, also described further hereinbelow, preprocessor 103 may not perform a reconversion back to a full pixel depth signal, but instead may supply the reduced color depth output directly to video encoder 105. Such embodiments typically require the inclusion of a postprocessor, as described further hereinbelow.

Video encoder 105 receives the reduced resolution signal supplied as an output by preprocessor 103 and encodes it for transmission or storage. The encoding process employed may be lossy or lossless.

Recording/transmission 107 indicates the method and medium by which the encoded video signal eventually is supplied to video decoder 109. For example, recording/transmission 107 could be a digital communication system. Alternatively, recording/transmission 107 might be an arrangement that includes a disk writer, a disk that is written with the encoded video signal by the disk writer, and a disk reader that retrieves the encoded video signal from the disk.

Video decoder 109 receives the encoded video signal from recording/transmission 107 and decodes it to produce a decoded video signal that is supplied to either optional preprocessor 111, if present, or to display 113 when optional preprocessor 111 is not present. The video signal produced by video decoder 109 may be identical to that supplied to video encoder 105 if video encoder 105 employs a lossless encoding method, or it may differ somewhat therefrom if video encoder 105 employs a lossy encoding method, e.g., an MPEG-like encoding method.

Optional postprocessor 111, when present, essentially performs the inverse process of particular processing steps performed by preprocessor 103. Postprocessor 111 is required when preprocessor 103 performs additional chrominance reduction or the video supplied as an output by preprocessor 103 is not in RGB24 format. The conversion from YCbCr space back to RGB may be performed as described above.

Display 113 receives a reconstructed RGB24 video signal, either from video decoder 109 or postprocessor 111 and displays the video signal in accordance with the reduced-pixel-depth format that it is internally capable of handling due to its limited resources.

As indicated hereinabove, in some embodiments of the invention preprocessor 103 may perform a further prescribed reduction in the resolution of the chrominance component of the video signal, i.e., a further reduction in pixel depth, as describe further hereinbelow. For example, in one embodiment of the invention, preprocessor 103 optionally performs additional optional color depth reduction on the chrominance component only. Doing so does not significantly affect a viewer of the ultimately reconstructed image even though information is lost because the human visual system is very sensitive to small changes in luminance but is relatively insensitive to changes in chrominance.

In one embodiment of the invention, the chrominance pixel depth is reduced by linear shifting of the chrominance signal values to the right in preprocessor 103.

If (a) signal x represents the pixel of the video signal being processed by preprocessor 103, e.g., Y, Cb and Cr for the pixel, and (b) [symbol] represents the amount of color depth reduction, then for the embodiment of the invention where the preprocessor employs a linear right-shift technique for function F, preprocessor 103 computes B(((Ax+C)>>Δ)<<Δ)+D and takes from the result only the value for the luminance component, and it also computes (B·(((A·x+C)>>Δ)<<Δ)+D)>> [symbol] and takes from the result only the chrominance portions, thus further reducing the color depth. Since performing the additional color depth reduction is a many to one process, there are many possible reverse mappings that may be employed to reconstitute a full color depth format signal. For example, in for the above embodiment of the invention, postprocessor 111 may compute for each of the chrominance portions, (x′)<< [symbol] where signal x′ represents one portion of the chrominance signals of the pixel reconstructed by video decoder 109 in YCbCr24 space. Alternatively, postprocessor 111 may compute for each of the chrominance portions, ((x′)<< [symbol] )+(1<<( [symbol] −1)) where signal x′ represents one portion of the chrominance signals of the pixel reconstructed by video decoder 109 in YCbCr24 space.

Similarly, for the embodiment of the invention where preprocessor 103 employs a linear right-shift technique for function F while function G is left shift operator with a magnitude adjustment, the preprocessed the luminance component is determined by B·(((A·x+C)>>Δ)<<Δ+(1<<(Δ−1)))+D and taking the resulting luminance component value, while each of the chrominance portions are determined by computing (B·(((A·x+C)>>Δ)<<Δ+(1<<(Δ−1)))+D)>> [symbol] and taking each of the resulting chrominance portion values. Again, since performing the additional color depth reduction is a many to one process, there are many possible reverse mappings that may be employed to reconstitute a full color depth format signal. For example, in for the above embodiment of the invention, postprocessor 111 may similarly compute for each of the chrominance portions, (x′)<< [symbol] where signal x′ represents one portion of the chrominance signals of the pixel reconstructed by video decoder 109 in YCbCr24 space. Alternatively, postprocessor 111 may compute for each of the chrominance portions, ((x′)<< [symbol] )+(1<<( [symbol] −1)) where signal x′ represents one portion of the chrominance signals of the pixel reconstructed by video decoder 109 in YCbCr24 space.

Those of ordinary skill in the art will readily recognize that preprocessor 103 and postprocessor 111 may not be the only preprocessor and postprocessor employed in the system. Other preprocessor and postprocessors may be employed for such functions as noise reduction, color enhancement, other image enhancement and the like.

In yet further embodiments of the invention, also described further hereinbelow, preprocessor 103 may not perform a reconversion back to a full pixel depth signal, but instead may supply the reduced color depth output directly to video encoder 105. Such a preprocessor would be advantageous if video encoder 105 was a lossless encoder. As such, the reduced color depth version of the signal is supplied as output by preprocessor 103 and encoded by video encoder 105. The resulting video signal when reconstructed at video decoder 109 is then processed by postprocessor 111 to reconstruct a full pixel depth signal suitable to be supplied to display 111.

Note that although the full pixel-depth format hereinabove has generally been assumed to be RGB24, which is presently the most popular format. However, other full pixel-depth formats are gaining popularity, such as a format where 10 bits are employed for each of the R, G, an B, components, which we refer to as “RGB30”, and there is even the possibility of employing 12 bits per component and beyond. Those of ordinary skill in the art will readily be able to adapt the principles of the invention to such higher pixel-depth formats. Similarly, those of ordinary skill in the art will readily be able to adapt the principles of the invention to other reduced pixel-depth formats. Furthermore, as improvements are made in video technology, it is even possible for there to be embodiments of the invention such as where the full pixel-depth format is RGB30 and the reduced pixel-depth format is RGB24.

What is claimed is:

1. A video preprocessor receiving a first digital video bit stream in a first format and having a maximum first information content, said first video bit stream being intended for display on a display unit capable only of displaying said first digital video bit with a maximum of a second information content that is less than said first information content, wherein said video preprocessor develops from said first digital video bit stream a second digital video bitstream, the information content of said second digital video bit, stream being no more than that of said second information content.

2. The invention as defined in claim 1 wherein said second digital video bit stream is arranged in said first format.

3. The invention as defined in claim 1 wherein said first information content supports a first pixel depth and said second information content supports a second pixel depth, said first pixel depth being greater than said second pixel depth.

4. The invention as defined in claim 1 wherein said first format is one of the set comprising RGB24 and RGB30.

5. The invention as defined in claim 1 wherein said second format is one of the group consisting of RGB444, RGB555, and RGB565.

6. The invention as defined in claim 1 wherein said video preprocessor performs an additional prescribed reduction in the resolution of the chrominance component of the video signal beyond the reduction necessary to reduce the maximum information content of said second video bit stream so that it can be displayed on said display thereby causing the information content of said second digital video bit stream to be less than that of said second information content.

7. The invention as defined in claim 1 wherein said video preprocessor computes B·(((A·x+C)>>Δ)<<Δ)+D,
where
“<<” denotes a left shift operator,
Δ denotes a given shift amount,
x is the original input video signal,
A, B, C and D are matrices of values that are specified for conversion from a first video space to a second video space and vice-versa, and
“·” is the dot product operator.

8. The invention as defined in claim 1 wherein said video preprocessor computes B·(((A·x+C)>>Δ)<<Δ+(1<<(Δ−1)))+D,
where
“<<” denotes a left shift operator,
Δ denotes a given shift amount,
x is the original input video signal,
A, B, C and D are matrices of scalar values that are specified for conversion from a first video space to a second video space and vice-versa, and
“·” is the dot product operator.

9. The invention as defined in claim 1 wherein said video preprocessor:
computes B·(((A·x+C)>>Δ)<<Δ)+D and takes therefrom the resulting luminance component; and
computes (B·(((A·x+C)>>Δ)<<Δ)+D)>> [symbol] and takes therefrom each resulting the chrominance portion;
where [symbol]
represents the amount of color depth reduction,
“<<” denotes a left shift operator,
Δ denotes a given shift amount,
x is the original input video signal,
A, B, C and D are matrices of scalar values that are specified for conversion from a first video space to a second video space and vice-versa, and
“·” is the dot product operator.

10. The invention as defined in claim 1 wherein said video preprocessor:
computes B·(((A·x+C)>>Δ)<<Δ+(1<<(Δ−1)))+D and takes therefrom the resulting luminance component; and
computes (B·(((A·x+C)>>Δ)<<Δ+(Δ<<(Δ−1)))+D)>> [symbol] and takes therefrom each resulting the chrominance portion;
where [symbol]
represents the amount of color depth reduction,
“<<” denotes a left shift operator,
Δ denotes a given shift amount,
x is the original input video signal,
A, B, C and D are matrices of scalar values that are specified for conversion from a first video space to a second video space and vice-versa, and
“·” is the dot product operator.

11. The invention as defined in claim 1 wherein said video preprocessor determines
y′=G(F(y))
where y is the original full-pixel-depth video signal supplied as an input to said video preprocessor,
y′ is the reduced-pixel-depth signal supplied as an output by said video preprocessor,
F is a function that maps a video signal from a full-pixel-depth resolution to a reduced-pixel-depth resolution,
G is a function that maps from said reduced-pixel-depth resolution back to said full-pixel-depth resolution.

12. The invention as defined in claim 11 wherein F is a right shift function.

13. The invention as defined in claim 11 wherein F is a division function.

14. The invention as defined in claim 11 wherein G is a left shift function.

15. The invention as defined in claim 11 wherein G is a shift left and add a value function.

16. The invention as defined in claim 11 wherein G is a multiplication function.

17. The invention as defined in claim 1 wherein said preprocessor calculates B(G(F(Ax+C)))+D
where
x is the original input video signal,
F is a function that maps a video signal from a full-pixel-depth resolution to a reduced-pixel-depth resolution,
G is a function that maps from said reduced-pixel-depth resolution back to said full-pixel-depth resolution,
A, B, C and D are matrices of scalar values that are specified for conversion from a first video space to a second video space and vice-versa, and
“·” is the dot product operator.

18. The invention as defined in claim 17 wherein said first video space is RGB and said second video space is YCbCr.

19. The invention as defined in claim 17 wherein
$$\begin{matrix}A = ( \begin{matrix}1.0 & 0 & 0.114 \\ 1.0 & - 0.336 & - 0.698 \\ 1.0 & 1.732 & 0\end{matrix} ) & C = ( \begin{matrix}- 175.5 \\ 132.4 \\ - 221.7\end{matrix} ) \\ B = ( \begin{matrix}0.299 & 0.587 & 0.114 \\ - 0.172 & - 0.339 & 0.511 \\ 0.511 & - 0.428 & - 0.083\end{matrix} ) & D = ( \begin{matrix}0 \\ 128.0 \\ 128.0\end{matrix} )\end{matrix}$$

20. The invention as defined in claim 1 wherein said video processor reduces the information content of at least one chrominance portion of said video signal so that the information of said second digital video bit stream is less than said second information content as part of developing said second digital video signal from said first digital video signal.

21. The invention as defined in claim 20 wherein said further reduction is achieved by right shifting said at least one chrominance component more than said luminance component is right shifted.

22. A video postprocessor for restoring the format of the chrominance component of a received video signal, said received video signal having been processed by a video preprocessor that processed a first digital video bit stream in a first format and having a maximum first information content, said video bit stream being intended for display on a display unit capable only of displaying video with a maximum of a second information content that is less than said first information content, wherein said video preprocessor develops from said first digital video bit stream a second digital video bit stream, said second video bit stream being coupled to said video postprocessor, the information content of said second digital video bit stream being no more than that of said second information content.

23. The invention as defined in claim 22 wherein said second video bit stream is in said first format.

24. The invention as defined in claim 22 wherein said second video bit stream is coupled to said video postprocessor via at least of the group consisting of a transmission system and a storage system.

25. The invention as defined in claim 22 wherein said second video bit stream is coupled to said video postprocessor via at least a video encoder and a video decoder.

26. The invention as defined in claim 25 wherein said encoder employs a lossy encoding process.

27. The invention as defined in claim 25 wherein said encoder employs a lossless encoding process.

28. The invention as defined in claim 25 wherein said encoder employs a lossless encoding process and said second video signal is in a format other than said first format.

29. The invention as defined in claim 22 wherein the information content of said second digital video bit stream is less than that of said second information content because said video preprocessor performed an additional prescribed reduction in the resolution of the chrominance component of the video signal beyond the reduction necessary to reduce the maximum information content of said second video bit stream so that it can be displayed on said display.

30. The invention as defined in claim 29 wherein said video postprocessor computes (x′)<< [symbol] ,
where
“<<” denotes a left shift operator,
Δ denotes a given shift amount,
x′ represents one portion of the chrominance signal of said second digital bitstream in YCbCr24 space.

31. The invention as defined in claim 29 wherein said video postprocessor computes ((x′)<< [symbol] )+(1<<( [symbol] −1)),
where
“<<” denotes a left shift operator,
Δ denotes a given shift amount,
x′ represents one portion of the chrominance signal of said second digital bitstream in YCbCr24 space.

32. A system, comprising:
a video preprocessor receiving a first digital video bit stream in a first format and having a maximum first information content, said video bit stream being intended for display on a display unit capable only of displaying video with a maximum of a second information content that is less than said first information content, wherein said video preprocessor develops from said first digital video bit stream a second digital video bitstream, the information content of said second digital video bit stream being no more than that of said second information content, and said second digital video bit stream being arranged in said first format; and
a video encoder that encodes said second digital video bitstream and supplies as an output an encoded version of said second digital video bitstream.

33. The invention as defined in claim 32 wherein said video encoder is lossy.

34. The invention as defined in claim 32 wherein said video encoder is lossless.

35. The invention as defined in claim 32 further comprising a video decoder for developing a reconstructed video signal from said encoded version of said second digital video bitstream.

36. The invention as defined in claim 35 further comprising a display that receives said reconstructed video signal from said video decoder.

37. The invention as defined in claim 35 further comprising a display that receives said reconstructed video signal from said video decoder in RGB24 format.

38. The invention as defined in claim 35 further comprising:
a display; and
a postprocessor which receives said reconstructed video signal from said video decoder and supplies a postprocessed version of said reconstructed video signal to said display.

39. The invention as defined in claim 35 further comprising:
a display; and
a postprocessor which receives said reconstructed video signal from said video decoder and supplies a postprocessed version of said reconstructed video signal to said display in RGB24 format.

40. A method for use in a video preprocessor receiving a first digital video bit stream in a first format and having a first pixel depth, said first video bit stream being intended for display on a display unit capable only of displaying said first digital video bit with a maximum of a second pixel depth that is less than said first pixel depth, the method comprising the step of:
developing from said first digital video bit stream a second digital video bitstream, said second digital video bitstream having effectively the same pixel depth as said second format but being in said first format.

41. A video preprocessor, comprising:
means for receiving a first digital video bit stream in a first format and having a first pixel depth, said first video bit stream being intended for display on a display unit capable only of displaying said first digital video bit with a maximum of a second pixel depth that is less than said first pixel depth; and
means for developing from said first digital video bit stream a second digital video bitstream, said second digital video bitstream having effectively the same pixel depth as said second format but being in said first format.
